(19) United States
(12) Patent Application Publication
(10) Pub. No.: US 2001/0039139 A1
(43) Pub. Date: Nov. 8, 2001

(54) Insulation-displacement terminal contact, and a connecting terminal

(76) Inventors: Johann Herrmann, Guenther Weissberger (DE); Guenther Weissberger, Kelheim (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/773,607

(22) Filed: Feb. 2, 2001

(30) Foreign Application Priority Data
Feb. 4, 2000 (EP) 00102471.0

(51) Int. Cl. H01R 4/24

(52) U.S. Cl. 439/395

(57) ABSTRACT

An insulation-displacement terminal contact (1), for example for modular terminals, which has a slotted, sprung contact region as a contact-making slot (3) on a connecting bracket (2), which contact region is surrounded and reinforced by an outer spring clip (4), and which insulation-displacement terminal contact (1) has cutting blades (6) in the inlet region (5). The invention provides for the cutting blades (6) to project toward one another behind their inlet region (5).

The invention relates to an insulation-displacement terminal contact, for example for modular terminals, which has a slotted, sprung contact region as a contact-making slot on a connecting bracket, which contact region is surrounded and reinforced by an outer spring clip, in detail as claimed in the generic part of claim 1. In the inlet region, the spring clip can be configured to form cutting blades (such a configuration is known from § 3(2) PatG from DE 199 21 769.6).

The material of the spring clip can be matched to the spring characteristics, and the contact region in the connecting bracket can be matched to its electrically conductive characteristic.

If the cutting blades form an inlet region in front of the contact-making slot, the limbs of the connecting bracket point toward one another on the contact-making slot. It has been found that, in practice, the normal manufacturing tolerances mean that it is not always possible to ensure that the limbs lie in a plane. Without increasing the production cost by reducing the tolerances, it is possible in practice for the limbs to slide past one another, with an offset. This results in the connection relationships not being ensured uniformly.

The invention is based on the object of developing the insulation-displacement terminal contact described initially further so that constant connection characteristics are ensured with normal manufacturing tolerances.

According to the invention, the described object is achieved by an insulation-displacement terminal contact as claimed in claim 1. In this case, the cutting blades project toward one another behind their inlet region. Since the cutting blades are produced from the spring clip, or are at least rigidly connected to the spring clip, this makes it possible to ensure that the cutting blades project toward one another in a plane. The cutting blades can also be designed to be relatively flat in this region, so that they still project toward one another reliably, even slightly offset.

It is advantageous if the cutting blades have a profile which is stepped toward the front face, on their rear face, related to their front face with the conductor inlet, such that they engage with this profile in a corresponding profile in the connecting bracket and can open the latter when they are themselves forced apart from one another and are opened by a conductor being inserted. This avoids the need for an inlet region in the contact-making slot, so that, when a previously connected conductor is removed, it cannot hook itself behind the shoulder of blades.

It is also advantageous if, the end edges of the cutting blades project in front of the spring clip with respect to the conductor inlet. In consequence, a conductor which is to be inserted cannot become hooked on the front end faces of the spring clip. In fact, it is cleanly guided to the contact-making slot in the insertion region in the cutting blades.

All of these described embodiments jointly have the advantage that the cutting blades can be manufactured from a harder material than the material of the connecting bracket in the contact-making slot. During production of an insulation-displacement terminal contact of the described type, it is advantageous if the connecting bracket engages in the region of its contact-making slot in a support on the spring clip. The connecting bracket can be fixed on the support in the spring clip using a scraping technique. In the process, the material of the spring clip is crushed down onto the connecting bracket, like a scraper. The connecting bracket is in consequence connected to the spring clip without any play, thus avoiding tolerances such as those which can occur with window-like apertures.

The insulation-displacement terminal contact can be used in a connecting terminal, possibly with further insulation-displacement terminal contacts. The connecting terminals can be in the form of a modular terminal.

The invention will now be explained in more detail with reference to exemplary embodiments which are illustrated schematically in the drawing, in which:

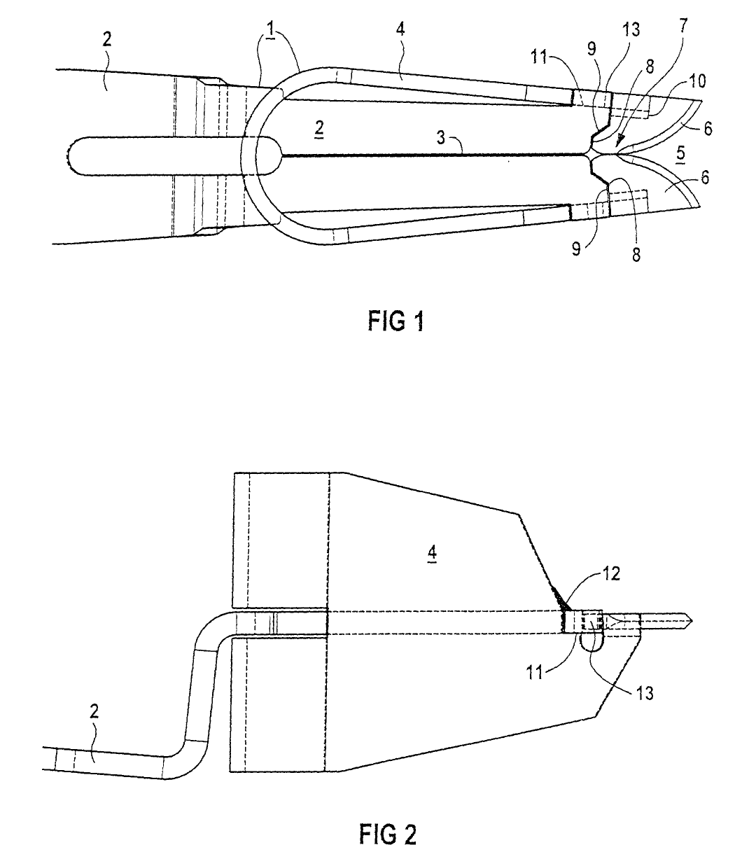

FIG. 1 shows a plan view of the contact-making slot and the cutting blades with the inlet region of an insulation-displacement terminal contact.

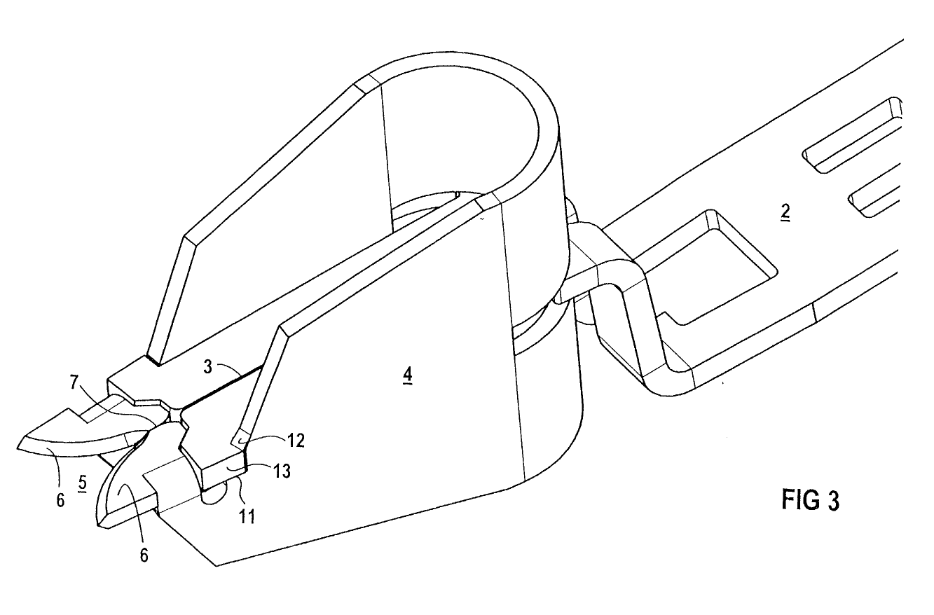

FIG. 2 shows a side view of the insulation-displacement terminal contact shown in FIG. 1.

FIG. 3 shows a perspective view of an insulation-displacement terminal contact.

The insulation-displacement terminal contact 1 shown in FIG. 1 has a slotted, sprung contact region as a contact-making slot 3 on a connecting bracket 2. The contact-making slot 3 is surrounded by an outer spring clip 4, and its spring force is reinforced. The spring clip 4 is designed in an inlet region 5 to form cutting blades 6. The essential feature is that the cutting blades 6 project toward one another in a projecting region 7 behind their inlet region 5. It is advantageous to design the limbs of the connecting bracket 2 on the contact-making slot 3 to be slightly offset to the rear, so that contact in the rest state takes place only in the projecting region 7.

On their rear face, related to their front face with the conductor inlet, the cutting blades 6 have a profile which is stepped toward the front face in such a manner that they engage in a corresponding profile 9 on the connecting bracket 2, opening the latter, when the cutting blades 6 are forced apart from one another when a conductor which is to be connected is inserted.

It is advantageous if, as shown in the exemplary embodiment, the cutting blades 6 project in front of the spring clip 4, with its end edges 10, with respect to the conductor inlet. In consequence, a conductor which is to be inserted cannot become hooked on the end edges. If, for connection of a conductor, this conductor is inserted with its insulation sheathing it into the inlet region 5 of the cutting blades 6, the cutting blades cut the insulation open, and the conductor which is to be inserted drives the cutting blades apart from one another, opening them. In consequence, the profile 8 of the cutting blades together with the opposing profile 9 on the connecting bracket drives the limbs of the connecting bracket along the contact-making slot 3, opening it.

In the region of its contact-making slot 3, the connecting bracket 2 engages in a support 11 on the spring clip 4. In this context, refer to FIGS. 2 and 3. The connecting bracket 2 is fixed on the support 11 in the spring clip 4 using a scraping technique. In the process, the material 12 of the spring clip 4 is crushed down onto a protruding tab 13 of the connecting bracket using a scraping technique, and the connecting bracket 2 is in consequence fixed to the spring clip 4.

FIG. 3 uses a perspective illustration of an exemplary embodiment to show that the cutting blades 6 are formed from the spring clip 4 by an appropriate cutting technique, and are moved into position by bending.

A connecting terminal, if necessary with further insulation-displacement terminal contacts, can be fitted with the insulation-displacement terminal contact. Such a connecting terminal may be in the form of a modular terminal.

1. An insulation-displacement terminal contact (1), for example for modular terminals, which has a slotted, sprung contact region as a contact-making slot (3) on a connecting bracket (2), which contact region is surrounded and reinforced by an outer spring clip (4), and which insulation-displacement terminal contact (1) has cutting blades (6) in the inlet region (5), characterized in that the cutting blades (6) project toward one another behind their inlet region (5).

2. The insulation-displacement terminal contact as claimed in claim 1, characterized in that the cutting blades (6) have a profile (8) which is stepped toward the front face, on their rear face, related to their front face with the conductor inlet, by means of which profile (8) they engage in a corresponding profile (9) of the connecting bracket (2), opening it.

3. The insulation-displacement terminal contact as claimed in claim 1 or 2, characterized in that the end edges (10) of the cutting blades (6) project in front of the spring clip (4) with respect to the conductor inlet.

4. The insulation-displacement terminal contact as claimed in one of the preceding claims, characterized in that the connecting bracket (2) engages in the region of its contact-making slot (3) in a support (11) on the spring clip (4).

5. The insulation-displacement terminal contact as claimed in claim 4, characterized in that the connecting bracket (2) is fixed on the support (11) in the spring clip using a scraping technique.

6. The insulation-displacement terminal contact as claimed in one of the preceding claims, characterized in that the cutting blades are designed to be relatively flat in their projecting region (7) in which they project toward one another.

7. A connecting terminal having at least one insulation-displacement terminal contact as claimed in one of claims 1 to 6.

8. The connecting terminal as claimed in claim 7, characterized in that said terminal is in the form of a modular terminal.
